(19) United States
(12) Patent Application Publication
(10) Pub. No.: US 2026/0252364 A1
(43) Pub. Date: Aug. 27, 2026

(54) SYSTEMS AND METHODS FOR DISPLAYING AUTONOMOUS VEHICLE GRAPHICAL USER INTERFACES

(71) Applicant: Stack AV Co., Mount Pleasant, PA (US)

(72) Inventors: Michael William DEASY, Pittsburgh, PA (US); Rohith KASHYAP, Fremont, CA (US)

(73) Assignee: Stack AV Co., Mount Pleasant, PA (US)

(21) Appl. No.: 19/059,875

(22) Filed: Feb. 21, 2025

(51) Int. Cl. G06F 9/451

(52) U.S. Cl. CPC G06F 9/451

(57) ABSTRACT

A system for displaying a graphical user interface of an autonomous vehicle using a progressive web application is provided. The system comprises one or more display devices storing instructions that cause the system to receive a progressive web application comprising the graphical user interface from a computing node communicatively coupled to the one or more display devices via a local network of the autonomous vehicle. The instructions further cause the system to receive, in one or more predefined formats, one or more autonomy messages from the computing node communicatively coupled to the one or more display devices via the local network. The instructions cause the system to convert, based on the progressive web application and the one or more predefined formats, the received one or more autonomy messages into one or more visual elements and display the one or more visual elements on the graphical user interface.

### FIELD

The present disclosure relates generally to displaying graphical user interfaces of autonomous vehicles and specifically to the use of web applications for the display of said interfaces.

### BACKGROUND

Current techniques for displaying graphical user interfaces (GUIs) in autonomous vehicles include displaying interfaces on applications that are native to and/or custom-built for on-board vehicle computing systems, commonly on displays built into a vehicle's dashboard. Native applications may be run on the computing nodes of an autonomous vehicle and may receive information directly from the autonomous control system of the vehicle to visualize the vehicle and its surroundings. Such approaches to providing user interfaces and visualization displays may lack portability, as execution of native visualization applications may be tied to specific vehicle hardware and/or software configurations.

### SUMMARY

Disclosed herein are systems and methods for displaying a graphical user interface (GUI) of an autonomous vehicle using a web application such as a progressive web application. Using a web application to display autonomous vehicle GUIs, systems and methods disclosed herein may enable a platform-independent approach to visualization of autonomy-related data and management of autonomous control software packages directly on devices including a web browser such as tablets, laptops, mobile phones, and/or built-in vehicle displays. An exemplary web application may be bundled with an autonomous control software package and downloaded to a computing node of the vehicle. A web server executing on the node may serve the web application to a display device within or proximate to the vehicle such as a tablet and/or laptop. The display device may execute the web application using a browser engine or rendering engine associated with a web browser installed on the display device.

In the case of a progressive web application-based user interface, the progressive web application may function locally on a display device by utilizing offline caching capabilities of the web browser. Following service of the progressive web application from a web server operating on a vehicle computing node, resources associated with the web application such as script files, model definitions, and/or image files may be stored in the browser's cache, optionally using a service worker associated with the progressive web application to facilitate this caching process. These cached resources enable the progressive web application to be re-launched and executed locally without requiring an active connection to the web server, allowing for offline use when connection between the progressive web application and web server is disrupted. In contrast, use of a traditional, non-progressive web application may involve an active connection to the web server during each session, as resources may be retrieved dynamically and not cached persistently for offline use.

An exemplary web application may be communicatively coupled to the autonomous control system of the vehicle via an autonomous control server. The web application may receive autonomy messages from the autonomous control system via the autonomous control server and may convert one or more of the messages into visual elements including, for example, visual representations of the autonomous vehicle, lane lines, and/or nearby vehicles, as well as visualizations of planned trajectories and/or sensor outputs. These visualizations may be rendered on the GUI, providing real-time feedback and/or operational insights to a driver present in the vehicle.

An exemplary web application may further facilitate administrative tasks such as autonomous control software package management, vehicle configuration specification, vehicle initialization and/or calibration procedures, and/or fault display and/or diagnostics. For example, a web application may enable a user to select, download, and/or install software packages; input vehicle-specific parameters including, for example, trailer type and/or weight; and/or identify vehicle faults or errors.

By using a web application to display an in-vehicle GUI for visualizing the vehicle and its operational environment, disclosed systems and method may provide additional flexibility relative to known techniques that may be based on native applications running on a vehicle's computing system. For example, a GUI may be displayed on different hardware endpoints, including a driver's tablet, a vehicle's built-in display, and/or a passenger's laptop, while being communicatively coupled to and receiving autonomy messages from the control system of the autonomous vehicle. The system simplifies the distribution and updating of the web application by bundling script files corresponding to the application with the autonomous control software packages, thereby ensuring that the web application and autonomous control software versions are synchronized, reducing the risk of incompatibilities or deployment errors.

In some embodiments, a system for displaying a graphical user interface of an autonomous vehicle using a progressive web application is provided, the system comprising: one or more display devices comprising one or more processors and memory storing instructions that, when executed by the one or more processors, cause the system to: receive a progressive web application comprising the graphical user interface from a computing node communicatively coupled to the one or more display devices via a local network of the autonomous vehicle; receive, in one or more predefined formats, one or more autonomy messages from the computing node communicatively coupled to the one or more display devices via the local network of the autonomous vehicle; convert, based on the progressive web application and the one or more predefined formats, the received one or more autonomy messages into one or more visual elements; and display the one or more visual elements on the graphical user interface.

In some embodiments, the progressive web application comprises one or more script files configured to generate the graphical user interface and convert, based on the one or more predefined formats, the received one or more autonomy messages into the one or more visual elements. In some embodiments, the one or more predefined formats are based on one or more data models defined within a control system of the autonomous vehicle and the progressive web application. In some embodiments, the one or more predefined formats comprise at least one format selected from a group consisting of a cuboid model format, a spline format, a waypoint format, and a format pairing an identifier with a vehicle system value. In some embodiments, displaying the one or more visual elements on the graphical user interface comprises executing the progressive web application using a browser engine. In some embodiments, the progressive web application is received from a web server of the computing node communicatively coupled to the one or more display devices. In some embodiments, the display device continues to display the one or more visual elements on the graphical user interface in the absence of an active connection to the web server of the computing node. In some embodiments, the one or more visual elements on the graphical user interface are displayed in the absence of an active connection using one or more resources associated with the progressive web application stored in the browser's cache. In some embodiments, a service worker associated with the progressive web application is used to manage the caching of the one or more resources. In some embodiments, the one or more autonomy messages are received from an autonomous control server of the computing node communicatively coupled to the one or more display devices. In some embodiments, the computing node communicatively coupled to the one or more display devices is further communicatively coupled to a control system of the autonomous vehicle. In some embodiments, the one or more visual elements on the graphical user interface comprise one or more software package information affordances that, upon selection, cause the system to display information corresponding to at least one autonomous control software package. In some embodiments, the one or more visual elements on the graphical user interface comprise one or more software package download affordances that, upon selection, cause the system to download at least one autonomous control software package to a control system of the autonomous vehicle. In some embodiments, the one or more visual elements on the graphical user interface comprise one or more software package installation affordances that, upon selection, cause the system to install at least one autonomous control software package onto a control system of the autonomous vehicle. In some embodiments, the one or more visual elements on the graphical user interface comprise one or more configuration input affordances that, upon selection, cause the system to enable user input of at least one of a vehicle type, a vehicle length, or a vehicle weight. In some embodiments, the instructions further cause the system to transmit the user input to an autonomous control server of a computing node communicatively coupled to the one or more display devices and communicatively coupled to a control system of the autonomous vehicle. In some embodiments, the one or more visual elements on the graphical user interface comprise one or more calibration instruction affordances that, upon selection, cause the system to display one or more instructions for performing at least one calibration procedure associated with the autonomous vehicle. In some embodiments, the one or more visual elements on the graphical user interface comprise one or more error information affordances that, upon selection, cause the system to display information corresponding to at least one error associated with the autonomous vehicle. In some embodiments, the one or more visual elements on the graphical user interface comprise a real-time representation of at least one of the autonomous vehicle, a vehicle proximate to the autonomous vehicle, lane line markings, or traffic signs. In some embodiments, the one or more visual elements on the graphical user interface comprise a real-time representation of at least one planned trajectory of the autonomous vehicle. In some embodiments, the one or more visual elements on the graphical user interface comprise an indication of an output of one or more sensors of the autonomous vehicle. In some embodiments, the one or more visual elements on the graphical user interface comprise one or more status indicators corresponding to a control system of the autonomous vehicle, wherein the one or more status indicators display at least one operational state, at least one diagnostic message, or both. In some embodiments, the one or more visual elements on the graphical user interface comprise one or more selection affordances that, upon selection, cause the system to display at least one type of visual element selected from a group consisting of: vehicles proximate to the autonomous vehicle, planned trajectories of the autonomous vehicle, indications of an output of one or more sensors of the autonomous vehicle, and status indicators corresponding to the control system of the autonomous vehicle. In some embodiments, the one or more display devices comprise at least one of a tablet, a laptop, a vehicle display, or a mobile phone.

In some embodiments, a method for displaying a graphical user interface of an autonomous vehicle using a progressive web application is provided, the method comprising: receiving a progressive web application comprising the graphical user interface from a computing node communicatively coupled to the one or more display devices via a local network of the autonomous vehicle; receiving, in one or more predefined formats, one or more autonomy messages from the computing node communicatively coupled to the one or more display devices via the local network of the autonomous vehicle; converting, based on the progressive web application and the one or more predefined formats, the received one or more autonomy messages into one or more visual elements; and displaying the one or more visual elements on the graphical user interface.

In some embodiments, a non-transitory computer readable storage medium storing instructions for displaying a graphical user interface of an autonomous vehicle using a progressive web application is provided, wherein the instructions, when executed by one or more processors of an electronic device, cause the device to: receive a progressive web application comprising the graphical user interface from a computing node communicatively coupled to the one or more display devices via a local network of the autonomous vehicle; receive, in one or more predefined formats, one or more autonomy messages from the computing node communicatively coupled to the one or more display devices via the local network of the autonomous vehicle; convert, based on the progressive web application and the one or more predefined formats, the received one or more autonomy messages into one or more visual elements; and display the one or more visual elements on the graphical user interface.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for displaying a graphical user interface (GUI) of an autonomous vehicle using a web application, according to some embodiments.

FIG. 1B depicts an exemplary autonomous control software bundle including a web server and web application, according to some embodiments.

FIG. 1C depicts an exemplary process for displaying a graphical user interface of an autonomous vehicle using a web application, according to some embodiments.

FIG. 2 depicts an exemplary graphical user interface for displaying autonomous control software packages, according to some embodiments.

FIG. 3 depicts an exemplary graphical user interface for displaying an autonomous vehicle configuration menu, according to some embodiments.

FIG. 4A depicts an exemplary graphical user interface for displaying a visualization of an autonomous vehicle and its surrounding environment, according to some embodiments.

FIG. 4B depicts an exemplary graphical user interface for displaying a visualization of an autonomous vehicle's planned trajectory, according to some embodiments.

FIG. 5A depicts an exemplary graphical user interface for displaying an initial autonomous vehicle calibration information, according to some embodiments.

FIG. 5B depicts an exemplary graphical user interface for displaying a first step of autonomous vehicle calibration, according to some embodiments.

FIG. 5C depicts an exemplary graphical user interface for displaying a second step of autonomous vehicle calibration, according to some embodiments.

FIG. 5D depicts an exemplary graphical user interface for displaying a third step of autonomous vehicle calibration, according to some embodiments.

FIG. 6 depicts an exemplary graphical user interface for displaying autonomous control system faults, according to some embodiments.

FIG. 7 depicts an exemplary computing system, according to some embodiments.

### DETAILED DESCRIPTION

Disclosed herein are systems and methods for providing a graphical user interface (GUI) of an autonomous vehicle using a web application, which may include a progressive web application. The system may consist of an autonomous control system, distributed across one or more vehicle computing nodes, communicatively coupled to a web application executed on a display device. The one or more vehicle computing nodes may host one or more control systems, for example planning, perception, actuation, and/or localization systems, which may exchange data to enable the vehicle's autonomous operation. The web application may be served by a web server executing on a communication node, and autonomy-related messages from the control system may be transmitted via an autonomous control server to the web application. By processing these messages, the web application may render visual elements representing the vehicle, its environment, its planned trajectories, system status updates, and/or administrative GUI views.

Unlike traditional native applications, which may involve device-specific installations and configurations, the web application may function on a variety of devices using a browser engine. This platform-independent aspect of disclosed systems may improve flexibility for a user who may wish to view vehicle-related information on, for example a tablet and mobile phone in addition to a built-in display. Use of a progressive web application may provide additional benefits, such as offline caching, allowing the application to operate even when connection to the web server is disrupted.

The display device may execute the web application using a browser engine. The browser engine may interpret the script files of the web application, including data models and/or logic for rendering visual elements and/or interacting with the autonomous control system, to generate the GUI of the web application. The GUI may include real-time visualizations such as three-dimensional representations of nearby vehicles, lane markings, planned trajectories, and/or outputs from the vehicle's sensors. Additionally, the GUI may provide control affordances allowing the user to install software packages, configure parameters, initiate calibration processes, and/or debug system faults.

The web application may update its visualizations in response to autonomy messages received from the control system. For example, data from a perception system operating on a vehicle computing node may describe a detected object using a cuboid model that specifies its position, dimensions, and/or orientation. This information may be packaged into one or more autonomy messages and transmitted to the web application by the autonomy control server. The web application may interpret this data and render a visual element representing the object within the GUI. Similarly, detected lane markings may be represented by visual elements using spline models, while visual elements representing planned trajectories may be overlaid on other GUI elements.

To ensure the web application can readily interpret autonomy messages from the autonomous control system, the web application and the autonomous control system may share common data models and/or message formats, including object definitions and/or parameter structures used to describe detected objects, planned trajectories, and/or system states. Use of shared, predefined formats for messages and data transmissions may ensure the web application consistently and efficiently interprets the stream of autonomy messages that may be received from the autonomous control system during operation. For example, this integration may improve computational efficiency by reducing the need for complex data translations and/or transformations and reduces the risk of errors when visualizing messages from the autonomous control system.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

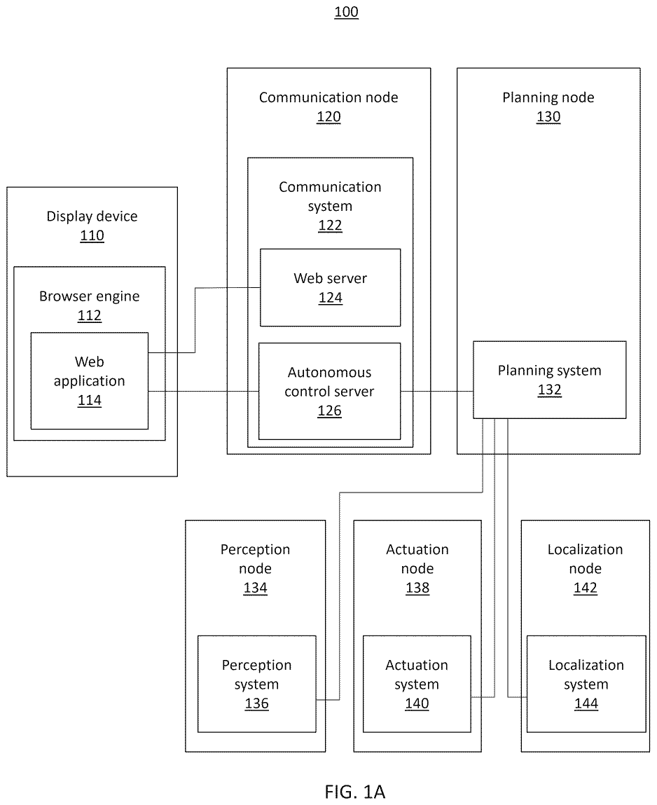

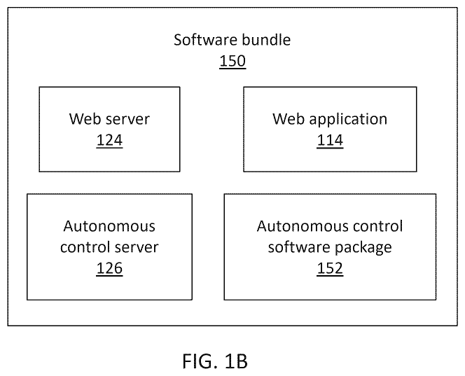

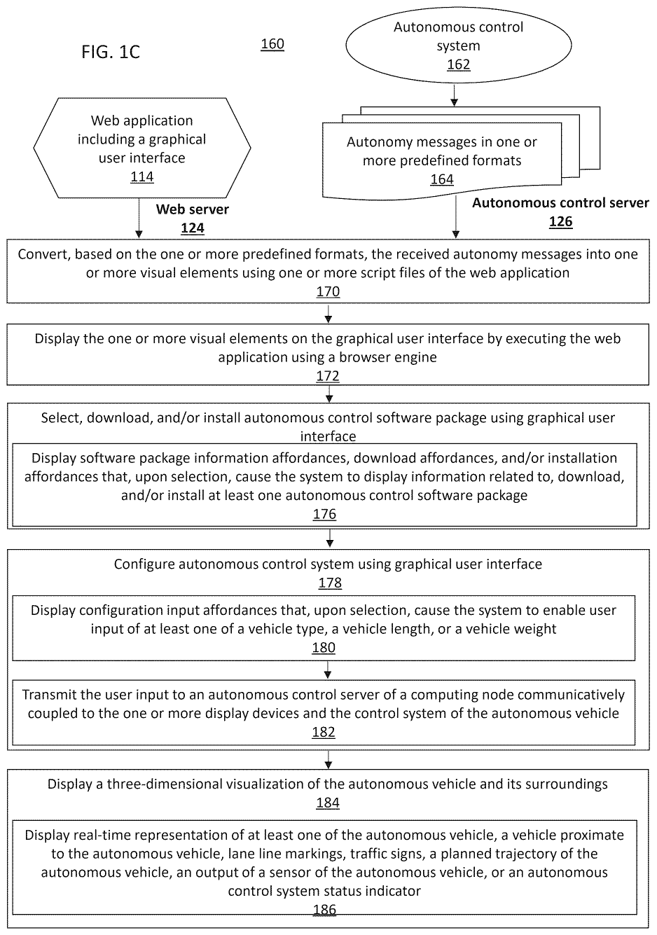

FIG. 1A depicts an exemplary system 100 for displaying a GUI of an autonomous vehicle using a web application. System 100 may include one or more vehicle computing nodes, for example communication node 120, planning node 130, perception node 134, actuation node 138, and/or localization node 142. Display device 110, configured to execute the web application-based GUI, may be connected, via communication node 120, to one or more other vehicle computing nodes of system 100 including, for example planning node 130. Planning node 130 may in turn be connected to one or more distributed nodes including, for example, perception node 134, actuation node 138, and/or localization node 142, that may be in turn connected to particular control and/or sensing assemblies associated with the autonomous control system.

Each of the one or more vehicle computing nodes may include a hardware module installed within the vehicle, equipped with its own processing capabilities, memory, and/or communication interfaces. Each vehicle computing node may function independently and/or collaboratively as part of a distributed architecture to perform specific tasks associated with the autonomous operation of the vehicle. Each vehicle computing node may include a software system configured to execute on the node, such that each node and system may be dedicated to a particular autonomous control aspect including, for example, communication, planning, perception, actuation, and/or localization.

For example, perception node 134 may be communicatively coupled to one or more vehicle perception sensors such as optical sensors, LiDAR sensors, and/or radar sensors. Perception node 134 may include a perception system 136, for example a software system or executable logic configured to run on perception node 134 and that may be configured to preprocess raw data received from the one or more perception sensors. This preprocessing might include detecting objects, identifying lane markings, and/or determining the vehicle's position relative to its environment. This preprocessed data may be sent to a planning system such as planning system 132 operating on a central planning node such as planning node 130. This preprocessed data may be sent as input data messages used by planning system 132 to generate autonomy control messages.

Similarly, actuation node 138 may be communicatively coupled to actuators of the autonomous vehicle including those associated with, for example, the vehicle's brakes, steering column, and/or accelerator. Actuation node 138 may include an actuation system 140, for example a software system or executable logic configured to run on actuation node 138 and that may be configured to determine the state of the actuators of the autonomous vehicle, providing this state information to planning system 132 as input data messages optionally used by planning system 132 to determine subsequent control steps. Actuation system 140 may additionally or alternatively receive from planning system 132 autonomy control messages indicating a particular trajectory to be followed and/or low-level commands to be issued to actuators including the vehicle's brakes, steering column, and/or accelerator to ensure the vehicle follows a planned trajectory.

Similar to the above nodes, localization node 142 may be communicatively coupled to one or more vehicle position sensors such as GPS sensors and/or IMU sensors. Localization node 142 may include a localization system 144, for example a software system or executable logic configured to run on localization node 142 and that may be configured to preprocess raw data received from the one or more position sensors. This preprocessing might include combining geographic coordinate information with vehicle orientation information to derive an estimated position of the vehicle. This preprocessed data may be sent to planning system 132 to determine a refined position of the vehicle or one or more planned trajectories. Alternatively or additionally, the functionality of localization system 144 and localization node 142 may be integrated with the functions of a perception system 136 and perception node 134 respectively.

Thus, one or more distributed vehicle computing nodes such as perception node 134, actuation node 138, and/or localization node 142 may process data from sensors and/or assemblies proximate to the node before transmitting that data to a central system, such as planning system 132, running on a central vehicle computing node such as planning node 130. By preprocessing data and sending messages including portions of the preprocessed data useful for centralized planning decisions, exemplary system 100 may reduce bandwidth usage by reducing the amount of data transmitted from one or more distributed nodes to one or more central nodes.

As shown in FIG. 1A, planning system 132 operating on planning node 130 may be communicatively coupled to detection and/or control systems executing on distributed nodes including, for example, perception system 136 of perception node 134 and actuation system 140 of actuation node 138. As described above, planning system 132 may be configured to exchange autonomy control messages and/or input data messages with said detection and/or control systems to inform and/or implement planning decisions. For example, planning system 132 may generate control signals and execute planning processes by integrating data received from perception system 136 corresponding to the detections by one or more vehicle sensors such as optical sensors, LiDAR sensors, and/or radar sensors. Such detections may include objects proximate to the autonomous vehicle, lane lines, and/or other environmental elements. Planning system 132 may use this data as an input to, for example, generate one or more planned trajectories for the autonomous vehicle. These one or more planned trajectories may then be transmitted as one or more autonomy control messages to, for example, actuation system 140. Actuation system 140 may in turn translate the received one or more autonomy messages into low-level commands and send said commands to the vehicle's steering, propulsion, and/or braking systems, thereby enabling the autonomous vehicle to follow the one or more planned trajectories.

In addition to the above-described systems and nodes, exemplary system 100 may include communication system 122. Similar to planning system 132, perception system 136, actuation system 140, and/or localization system 144, communication system 122 of communication node 120 may be communicatively coupled to one or more other systems and/or nodes of the autonomous vehicle. Communication system 122 may include, for example, web server 124 configured to serve web application 114 including a graphical user interface to display device 110 as discussed in further detail below. Communication system 122 may additionally or alternatively include an autonomous control server 126 that may be communicatively coupled to one or more other systems including, for example, planning system 132 of planning node 130 and web application 114 running on display device 110. Each of the above described components of system 100 including, for example, web application 114, web server 124, autonomous control server 126, planning system 132, perception system 136, actuation system 140, and/or localization system 144 may be communicatively coupled to one another through a local vehicle network, for example through a wireless WiFi network or a wired Ethernet network.

Display device 110 may include a combination of hardware and software components that enable it to process autonomy-related data, render GUIs, and/or render visualizations of the autonomous vehicle and its surroundings. Physically, display device 110 may include a display screen to render high-resolution visual images and a processor to execute browser engine 112 and interpret data received from web application 114. Display device 110 may also include memory for temporary data storage during operation and flash storage for caching web application resources thereby enabling continued operation of web application 114 when not connected to web server 124. Display device 110 may also include networking capabilities, such as a Wi-Fi and/or Ethernet module, to enable connection to the local network of the autonomous vehicle and in turn communication with web server 124.

As mentioned above, display device 110 may include one or more hardware endpoints such as a tablet, a laptop, and/or a built-in vehicle display integrated into, for example, the dashboard or infotainment system of the autonomous vehicle. Mobile phones with modern web browsers and sufficient processing capabilities may also serve as display device 110. A user may select which of the one or more display devices at their disposal to use based on whether a particular operational scenario involves device portability, intractability, and/or integration with the vehicle's existing systems. For example, a tablet may be used by a driver for mobility and ease of access, while a built-in display may serve as a back-up interface convenient for reference by vehicle operators while within and/or while operating the autonomous vehicle. This flexibility may ensure redundancy and continued access to the GUI of web application 114 in cases where a particular display device becomes unavailable.

Web server 124 of communication system 122 may operate as a software-based server hosted on communication node 120 and may be responsible for serving web application 114 to display device 110. Web server 124 may be implemented using programming languages such as Go, which may be advantageous given its simplicity and ability to handle HTTP/HTTPS requests. Alternatively or additionally, web server 124 may be implemented using other languages, such as Python, Node.js, and/or C++. Web server 124 may store and/or deliver to display device 110 the files and/or resources associated with web application 114, including HTML, CSS, JavaScript, and/or other assets.

Autonomous control server 126 of communication system 122 may serve as an intermediary between web application 114 and other systems of the autonomous vehicle including planning system 132. Autonomous control server 126 may process and relay autonomy messages, including input data messages and autonomy control messages, between systems to which it is communicatively coupled. For example, autonomous control server 126 may transmit an autonomy message containing information about an object proximate to the autonomous vehicle. This message may include, for example, a distance vector and its magnitude relative to the autonomous vehicle, as detected by a LiDAR sensor communicatively coupled to perception system 136. This message may additionally include parameters necessary to construct a representation of the object, for example a three-dimensional representation, including, for example, the object's height, width, depth, and/or orientation relative to the autonomous vehicle. Using this information, web application 114 may generate and render a representation of the object, for example a cuboid representation, within a visualization portion of a GUI displayed on display device 110. Similarly, autonomous control server 126 may relay from planning system 132 to web application 114 autonomy messages including planned trajectory data, computed velocity based on data from localization system 144, and/or actuator state information from actuation system 140.

Such autonomy messages provided by autonomous control server 126 to web application 114 may adhere to predefined formats or protocols, and/or may be based on data models that are shared between planning system 132 and web application 114, such as cuboid model formats for detected objects, spline model formats for lane markings, and/or waypoint formats for planned trajectories. To efficiently encode and/or decode these messages, the system may use protocol buffers that may provide a compact and/or structured format to reduce storage usage and/or improve processing efficiency. By using protocol buffers, the system may ensure that autonomy messages are transmitted and/or parsed with minimal overhead, enabling faster interpretation and/or rendering of visual elements by web application 114.

This compatibility between web application 114 and the autonomous control system including planning system 132 may provide web application 114 more complete insights into autonomy messages provided by autonomous control server 126. This compatibility may further reduce the computational resources used and/or processing time taken by display device 110 to produce visual representations of the autonomous vehicle and nearby objects. As discussed below, said compatibility may arise from developing web application 114 using the same programming language and/or shared object model definitions as the autonomous control system, and/or from bundling the web application with the autonomous control system software to ensure both are delivered to the autonomous vehicle as a unified package.

The process of serving web application 114 from web server 124 may begin when display device 110 connects to communication node 120 over the vehicle's local network, for example, using a WiFi and/or Ethernet connection. Display device 110 may execute a browser engine 112 capable of interpreting and displaying web application 114, which may include a progressive web application, using rendering engines including, for example, WebKit, Blink, and/or Gecko.

For a traditional, non-progressive web application, browser engine 112 may retrieve one or more script files containing code corresponding to web application 114, written for example in HTML, CSS, and/or JavaScript, and execute the one or more script files, displaying the resulting GUI. These script files may need to be fetched from web server 124 during each session. Additionally, autonomy messages from autonomous control server 126 may be transmitted to web application 114 using one or more data streaming protocols, such as WebSockets, Server-Sent Events, and/or HTTP polling, allowing web application 114 to update the GUI in real time.

For a progressive web application, browser engine 112 may additionally retrieve service worker scripts, which may enable caching of web application resources locally on display device 110. This caching may enable offline operation of web application 114, such that the GUI may continue to display previously cached data even if the connection to web server 124 is temporarily lost. Furthermore, for a progressive web application, autonomy messages received via autonomous control server 126 using WebSockets or similar protocols may continue to be processed during offline operation.

Web server 124 may thus attempt to serve resources related to web application 114 to browser engine 112 at regular intervals. In the case of a non-progressive web application, web server 124 may serve web application 114 to browser engine 112 whenever browser engine 112 requests one or more script files and/or loads data associated with web application 114. In the case of a progressive web application, web server 124 may also serve web application 114 and/or updated resources to browser engine 112 when browser engine 112 requests them. Furthermore, as discussed above, in the case of a progressive web application, previously cached resources may be retrieved locally without requiring an active connection.

The GUI of web application 114 may display real-time visualizations of the autonomous vehicle, such as three-dimensional models of the vehicle and its surroundings, lane lines, nearby objects, planned trajectories, and/or sensor outputs. These visualizations may be updated dynamically as web application 114 receives new autonomy messages from autonomous control server 126. For example, a first autonomy message, originating as an input data message from perception system 136, may instruct web application 114 to render, using browser engine 112, a detected obstacle. A second autonomy message, representing a planned trajectory generated by planning system 132, may be used to render, on the GUI of web application 114, an intended vehicle path around the obstacle. In the case of a progressive web application, these updates may persist even if connection to web server 124 is interrupted, as the application can use cached resources for visualization and maintain communication with autonomous control server 126 through protocols such as WebSockets.

As discussed in further detail below, in addition to visualizations, web application 114 may also include interactive affordances, such as buttons and/or input fields, enabling users to perform administrative tasks. For example, a user may input vehicle-specific parameters, such as trailer type or payload weight, via web application 114, which may then send messages corresponding to the parameters to autonomous control server 126 for processing by planning system 132. Similarly, a user may select and download autonomous control software packages, initiate calibration processes, and/or view control system fault information through the GUI. As with visualization information displayed on the GUI, information displayed for administrative tasks may take the form of messages provided by one or more elements of exemplary system 100, for example information provided by planning system 132. In this way, communication system 122 of communication node 120 may serve as an intermediary between web application 114 running on display device 110, serving the application via web server 124, and providing and/or receiving autonomy messages from one or more other elements of system 100 via autonomous control server 126.

In addition or as an alternative to the above-described architecture of system 100, in place of autonomous control server 126, web server 124 may be communicatively coupled to web application 114 and to planning system 132. In this way, web server 124 may both serve web application 114 and transmit autonomy messages to web application 114 received from planning system 132. Such an approach may simplify the architecture of system 100 by consolidating the roles of serving the web application and transmitting autonomy messages within web server 124, thereby reducing communication layers.

In addition or as an alternative to the architecture of system 100, in place of planning node 130 and/or planning system 132, autonomous control server 126 and/or web server 124 may be directly communicatively coupled to one or more systems operating on one or more distributed vehicle computing nodes, for example including perception system 136, actuation system 140, and/or localization system 144. Such an approach may streamline data exchange and potentially reduce latency by avoiding forwarding of messages through an intermediate system.

In addition or as an alternative to the architecture of system 100, for example including central vehicle computing nodes and/or distributed vehicle computing nodes, a single physical computing unit may virtually host multiple logical nodes using software-based partitioning or containerization techniques. For example, a central vehicle computing node such as planning node 130 may execute multiple logical or virtual systems, similar to communication system 122, planning system 132, localization system 144, and/or perception system 136, each operating as an isolated software process or containerized instance. These logical or virtual systems may share common hardware resources, such as processors, memory, and communication interfaces, while remaining functionally distinct. Such an approach may reduce hardware overhead and enable dynamic allocation of computational resources based on system demands.

FIG. 1B depicts an exemplary autonomous control software bundle 150 including web server 124, autonomous control server 126, web application 114, and/or one or more autonomous control software packages 152. Software bundle 150 may be received by system 100 from an external source, such as an external server communicatively coupled to one or more nodes, for example communication node 120, and/or from a physical medium, such as a USB drive.

Web server 124 and/or autonomous control server 126 may be included in software bundle 150 as executable modules configured to operate on one or more vehicle computing nodes, for example on communication node 120.

As mentioned above, web application 114 may include a set of script files that may be written in, for example, HTML, CSS, and/or JavaScript. Said script files may additionally or alternatively include additional resources such as images, for example used to form icons, textures, and/or diagrams within the GUI, and/or model definitions to support visual elements rendered on the graphical user interface (GUI), for example three-dimensional model definitions. These model definitions may define geometry, dimensions, and/or additional attributes of objects that can be visualized in a two-dimensional or three-dimensional space. For example, a cuboid model may be used to represent the autonomous vehicle itself and/or nearby objects detected by the autonomous vehicle. Parameters may be used to represent model variables including, for example, height, width, depth, and/or position. These variables, in combination with measurements made, for example, by sensors communicatively coupled to perception system 136 may enable visualization of the autonomous vehicle and detected objects proximate to the vehicle. Similarly, a lane line model may include spline definitions to render curved lane markings based on detected lane geometries, enabling display on the GUI of the vehicle's relative position within its lane of travel. A pedestrian model may provide simplified representations including, for example, capsules or prisms, to indicate the detected positions of nearby pedestrians.

These model definitions may enable web application 114 to convert autonomy messages received from planning system 132 via autonomous control server 126 into visualizations by integrating data originally generated by, for example, perception system 136. For example, a LiDAR sensor communicatively coupled to perception system 136 may detect a nearby object and may transmit an autonomy message to planning system 132 with data including, for example, direction vector and magnitude of distance from the autonomous vehicle, object dimensions (e.g. height, width, and/or depth), and/or object orientation relative to the autonomous vehicle (e.g. yaw, pitch, and/or roll). Planning system 132 may apply use a cuboid model such as the above referenced above to generate equations and/or positions necessary to construct the model, for example. This model-forming data may then be transmitted as an autonomy message to web application 114 via autonomous control server 126. On account of being bundled with and/or being written in the same programming language as autonomous control software package 152, web application 114 may have access to the same cuboid model and may readily construct a visual representation of the detected object, for example a three-dimensional visual representation. Once constructed, this representation may be rendered on the GUI of web application 114, allowing a user to become aware of the detected object's location, size, and/or orientation relative to the autonomous vehicle.

One or more autonomous control software packages 152 in software bundle 150 may include executable programs, libraries, and/or configuration files. These components may be configured to enable operation of one or more of communication system 122 of communication node 120, planning system 132 of planning node 130, perception system 136 of perception node 134, actuation system 140 of actuation node 138, and/or localization system 144 of localization node 142. One or more autonomous control software packages 152 may additionally include executable modules for subtasks within one or more of the aforementioned systems, along with shared object model definitions as mentioned above to ensure compatibility across system 100.

Forming web application 114 and one or more autonomous control software packages 152 using similar programming languages and/or shared object model definitions offer advantages over known techniques in terms of compatibility of web application 114 and the one or more systems making up exemplary system 100. As discussed above, by bundling web application 114 with one or more autonomous control software packages 152, definitions of visual models, for example three-dimensional models, used by autonomous control systems such as perception system 136 and/or planning system 132 may be included directly with script files that form web application 114. This in turn may allow autonomy messages to be generated in one or more predefined formats by, for example, planning system 132, transmitted via autonomous control server 126, and received by web application 114. Web application 114 in turn may be configured to accept autonomy messages of the same predefined format used by planning system 132, for example selected from one or more predefined formats based on model definitions shared by web application 114, planning system 132, and/or perception system 136.

For example, a cuboid object model defined in both planning system 132 and web application 114 may take as inputs parameters including, for example, object position, height, width, and/or depth. One or more autonomy messages transmitted from planning system 132 to web application 114 via, for example, autonomous control server 126, may include an indication of the cuboid object model and/or measured input parameters. Following receipt of the one or more autonomy messages, web application 114 may combine the parameters with the predefined cuboid model to convert the messages into one or more visual elements. Said visual elements may include, for example, one or more two-dimensional or three-dimensional representations of the object in the GUI generated by web application 114.

Thus, use of predefined formats, for example shared model definitions, may reduce the need for conversion between different formats and/or data transformations that might result from the use of mismatched model definitions. This reduced need for translation may ensure that autonomy messages transmitted between one or more of the systems making up exemplary system 100 are interpreted consistently and accurately. Once served to display device 110 and executed using browser engine 112, web application 114 can handle autonomy messages in their native format, avoiding inefficient additional process steps. Additionally, bundling web application 114 with one or more autonomous control software packages 152 in software bundle 150 may simplify the need for individual updates and/or synchronization processes. That is, when one or more autonomous control software packages 152 are updated, the script files of web application 114 may be updated as part of the same process. This in turn may ensure both remain in sync without a separate distribution channel and/or separate version management process.

Software bundle 150 may be received by system 100 from an external source such as an external server that may be communicatively coupled to one or more nodes of system 100 including, for example, to communication node 120. Software bundle 150 may additionally or alternatively be received from a physical medium such as a USB drive. Once received, software bundle 150 may undergo an installation process enabling constituent components to be deployed to respective systems. For example, web server 124 and/or autonomous control server 126 may be installed onto communication system 122 of communication node 120, enabling web application 114 to be served to device 110 and autonomy messages to reach and be transferred from web application 114, respectively.

Web application 114, included in software bundle 150, may be configured to be served to display device 110 by web server 124, where it may be executed by browser engine 112 to render the associated GUI. One or more autonomous control software packages 152 may then be distributed to various vehicle computing nodes of exemplary system 100, such as planning node 130, perception node 134, actuation node 138, and/or localization node 142. Such distribution may ensure each node receives the specific executable modules and/or libraries to form planning system 132, perception system 136, actuation system 140, and/or localization system 144, respectively. This structured installation process may ensure that each component of software bundle 150 is appropriately versioned and synchronized, such that the risk of mismatched versions and/or component incompatibility may be minimized.

FIG. 1C depicts an exemplary process 160 for displaying a GUI of an autonomous vehicle using web application 114 running on display device 110. The autonomous control system 162 may form a distributed system including multiple vehicle computing nodes, each hosting a system enabling one or more aspects of autonomous operation. For example, as depicted in FIG. 1A, autonomous control system 162 may include communication system 122 of communication node 120, planning system 132 of planning node 130, perception system 136 of perception node 134, actuation system 140 of actuation node 138, and/or localization system 144 of localization node 142.

Autonomy messages 164 may be received from autonomous control system 162, for example planning system 132 of planning node 130, and may be in one or more predefined formats, for example corresponding to shared object model definitions. As described above, these messages may include information such as detected objects, lane line positions, planned trajectories, and/or system status indicators. For example, a message pertaining to a detected object may be transmitted in a cuboid model format, including parameters indicating object position, one or more object dimensions, and/or object orientation. Similarly, a message pertaining to lane line data may be transmitted in a spline format including, for example, one or more control points and/or coefficients associated with the spline. A message pertaining to a planned trajectory may be transmitted in a waypoint format that may include a series of position and velocity pairings that collectively define an intended path for the autonomous vehicle. Additionally, a message pertaining to one or more system status indicators may use a format pairing an identifier with a value to represent states of one or more systems of exemplary system 100. Such pairings may include, for example, “actuation system: brake control active” or “planning system: idle.” These messages may be transmitted to web application 114 via autonomous control server 126 of communication system 122 as described above. Use of such predefined formats native to both the autonomous control system 162 and web application 114, may ensure that web application 114 understands information conveyed in the autonomy messages without additional translation and/or transformation steps.

As described above, web application 114, including script files and other application resources such as object model definitions, may be served to display device 110 via web server 124. At step 170 of exemplary process 160, web application 114 may convert received autonomy messages 164, based on their predefined formats, into one or more visual elements using the script files of web application 114. These script files may include pre-defined models and/or rendering instructions written in HTML, CSS, and/or JavaScript. For example, data originating from perception system 132 may include parameters indicating a detected object's position, dimensions, and/or orientation. These parameters may be combined with information corresponding to, for example, a cuboid model definition by planning system 132 and resulting autonomy messages may be transmitted to web application 114 via autonomous control server 126. Web application 114 in turn may convert these autonomy messages into, for example, a visual cuboid element using the same cuboid model definition. Said cuboid element may reflect the object's boundaries and spatial relationship to the autonomous vehicle. Similarly, web application 114 may convert autonomy messages including lane line data using a spline-based model, native to both web application 114 and autonomous control system 162, into visual elements representing curved lane boundaries.

Once autonomy messages have been converted to one or more visual elements, at step 172, the visual elements may be displayed on the GUI by executing web application 114 using browser engine 112. Browser engine 112 may process script files, graphical elements, and/or related resources of web application 114 to display on the GUI, for example, a visualization of the autonomous vehicle, the vehicle's surroundings, and/or the operational state of the vehicle. In this way, the GUI may display real-time visualizations of detected objects, lane line markings, planned trajectories, and/or sensor outputs. These elements may update dynamically as web application 114 receives additional autonomy messages, ensuring the GUI reflects the autonomous vehicle's real-time operating environment. For example, the position and/or orientation of a visual object representing a detected vehicle may be updated at a particular frequency, while a visual object representing a planned trajectory may be overlaid to show the intended path of the autonomous vehicle, updating as the vehicle moves along the path.

Display of such real-time visualizations on the GUI may be controlled using one or more selectable visual elements. These visual elements may include one or more selection affordances that, when selected by a user, cause the system to modify the displayed content based on the preferences of the user. For example, one or more selection affordances may allow the user to toggle the display of vehicles proximate to the autonomous vehicle, providing a visual representation of detected objects using, for example, cuboid models. Similarly, one or more selection affordances may enable the display of planned trajectories, allowing the user to see the predicted path of the autonomous vehicle based on current sensor inputs and/or planning decisions. The GUI may also include one or more selection affordances that reveal sensor outputs, such as LiDAR point clouds, camera detections, and/or radar data to increase the user's situational awareness. Additionally or alternatively, the GUI may include one or more selection affordances that control the visibility of status indicators corresponding to the control system of the autonomous vehicle including, for example, diagnostics for planning, actuation, and/or network connectivity.

In addition to visualizations of the autonomous vehicle and its surroundings, the GUI of web application 114 may enable display of information and/or performance of actions related to maintenance and/or administration of system 100. Similar to visualization displays, information for maintenance and/or administrative displays may be based on autonomy messages sent to web application 114 from autonomous control system 162 and/or autonomy messages sent to autonomous control system 162 from web application 114, for example via autonomous control server 126. For example, at step 174, the GUI may enable a user to select, download, and/or install one or more autonomous control software packages 152. This may be accomplished by, at step 176, displaying software package information affordances for reviewing autonomous control software package information, downloading one or more packages, and/or initiating their installation. The GUI may additionally enable a user to switch between a dark mode display configuration and a light mode display configuration.

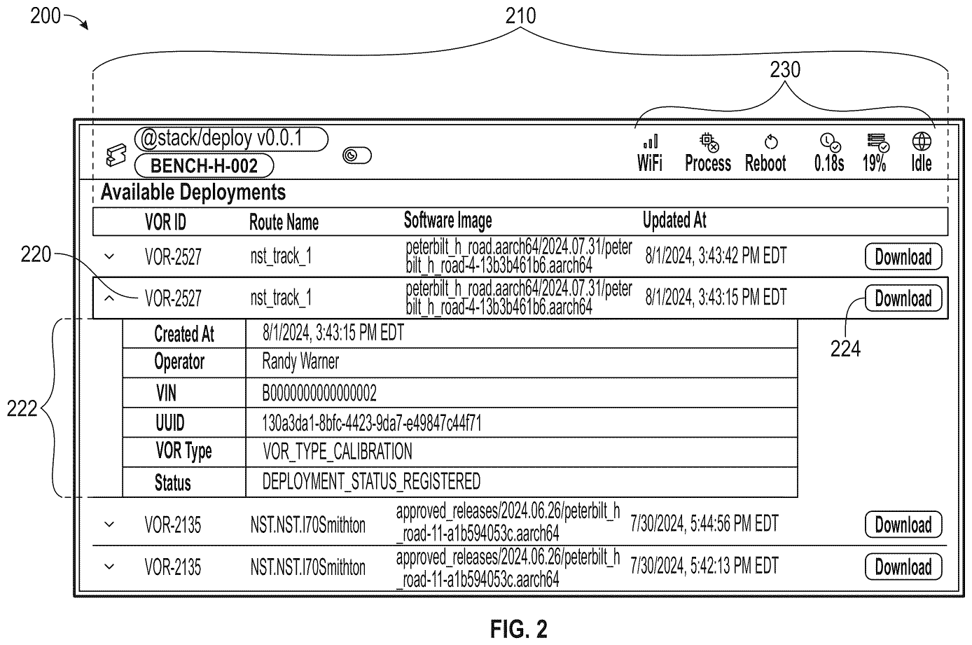

As shown in FIG. 2, a GUI view 200 may display a list of software package information affordances, for example software package information affordance 220, each displaying information corresponding to a particular autonomous control software package that may be referred to as a “deployment.” This information may include metrics 210 such as identifying information, routing information, software build information, and/or the date the particular package was made available, for example on a cloud server communicatively coupled to exemplary system 100. Selecting a particular software package information affordance may enable a user to view further information corresponding to the selected affordance. For example, selecting affordance 220 may cause web application 114 to display information 222 corresponding to the particular autonomous control software package represented by affordance 220 such as creation date, vehicle operator name, vehicle identification number, a unique identifier, type, and/or deployment status.

GUI view 200 may further include one or more download affordances and one or more installation affordances, with one download and/or installation affordance associated with one software package information affordance. For example, FIG. 2 depicts one or more download affordances associated with each information affordance, including download affordance 224 associated with information affordance 220. Such download and/or installation affordance may enable a user to download and/or install a particular autonomous control software package of the one or more autonomous control software packages 152. Selection of download affordance 224 may cause system 100 to download the autonomous control software package associated with information affordance 220. System 100 may communicate with, for example, a cloud server on which the autonomous control software package is stored causing the package to be downloaded to system 100, for example to communication node 120. Selection of an installation affordance may cause system 100 to install the autonomous control software package onto one or more systems and/or vehicle computing nodes forming system 100. For example, autonomous control software package may be installed onto one or more of communication node 120, planning node 130, perception node 134, actuation node 138, and/or localization node 142 so as to update, respectively, communication system 122, planning system 132, perception system 136, actuation system 140, and/or localization system 144.

GUI view 200 may additionally or alternatively include one or more status indicators and control affordances 230. These may include, for example, a network connectivity indicator to display the current connection status of web application 114 to autonomous control server 126, indicated as a color such that green may indicate an active connection while yellow or grey may indicate a low bandwidth connection or absence of a connection respectively. A task processing indicator may show whether web application 114 is actively executing any tasks, again using color to indicate status. Metrics 230 may also include a reboot control affordance that, when selected by a user, may prompt system 100 to restart one or more computing nodes of the autonomous vehicle. Additional status indicators may provide information such as task completion time, displaying the duration of the most recently completed operation. Metrics 230 may additionally include a data storage usage display, showing the percentage of memory currently in use, optionally colored based on level of usage, with green indicating low usage, yellow indicating moderate usage, and red indicating high usage. Metrics 230 may additionally include an external network activity indicator, indicating whether any data is being exchanged outside of the local vehicle network. One or more of the above-described indicators and control affordances may enable a user to monitor and manage operational state of web application 114 using single GUI view 200.

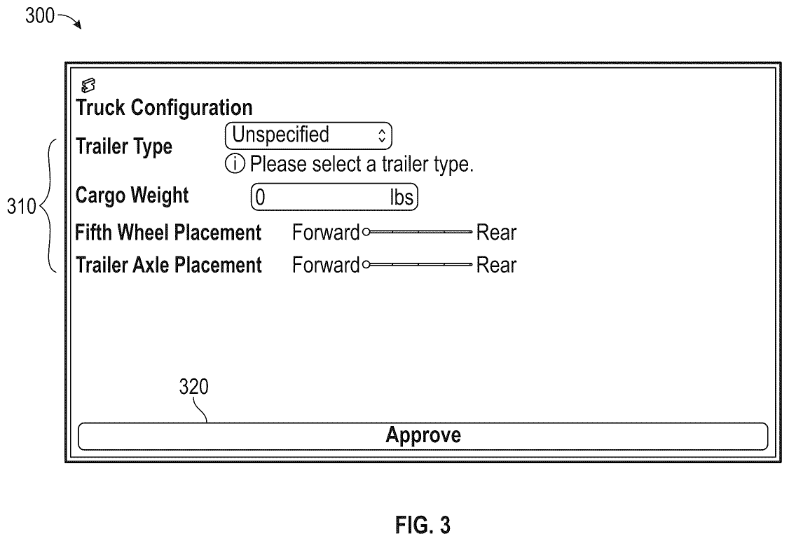

At step 178, web application 114 may facilitate inputting of one or more parameters of the autonomous vehicle, so as to configure system 100, using one or more interactive affordances. For example, at step 180, display device 110 may display affordances that enable a user to input parameters such as vehicle type, length, and/or weight. As depicted in FIG. 3, GUI view 300 includes input affordances 310 that may correspond to an autonomous tractor trailer vehicle. As depicted, exemplary input affordances 310 include a trailer type input affordance including a drop-down menu enabling selection of the type of trailer attached to the tractor of the vehicle (e.g. selection from among predefined trailers with known dimensions including length); a cargo weight input affordance including a text-entry field enabling entry of the weight of the trailer; a wheel placement input affordance including a slider bar enabling selection of the approximate position at which the connection between the trailer and the tractor is made; and/or a trailer axle placement input affordance including a slider bar enabling selection of the approximate position at which the axles of the trailer are located. Once a user finalizes input configuration parameters using input affordances 310, a user may select approval affordance 320, that may initiate transmission of the parameters to autonomous control system 162 as described in further detail below.

Entering of one or more of the above-described configuration parameters may serve as an important input process, allowing system 100 to account for changes in vehicle weight and/or dynamics. For example, by enabling input of trailer dimensions and/or weight, system 100 may ensure that planning system 132 and/or actuation system 140 account for changes in vehicle performance parameters derived from user inputs including, for example, vehicle turning radius and/or stopping distance. At step 182, web application 114 may transmit these user inputs to, for example, planning system 132 of the autonomous control system 162 via autonomous control server 126, enabling autonomous control system 162 to account for updated configuration parameters and/or confirm that configuration parameters remain unchanged.

Finally, at step 184, web application 114 may display a GUI including a visualization of the autonomous vehicle and its surroundings, based on autonomy messages received from autonomous control system 162 via autonomous control server 164. This visualization may be two-dimensional, for example a top-down view, or three-dimensional, for example a birds-eye view. Displaying this visualization may include, at step 186, displaying real-time representations of various elements including the autonomous vehicle itself, nearby objects, lane line markings, traffic signs, planned trajectories, sensor outputs, and/or system status indicators.

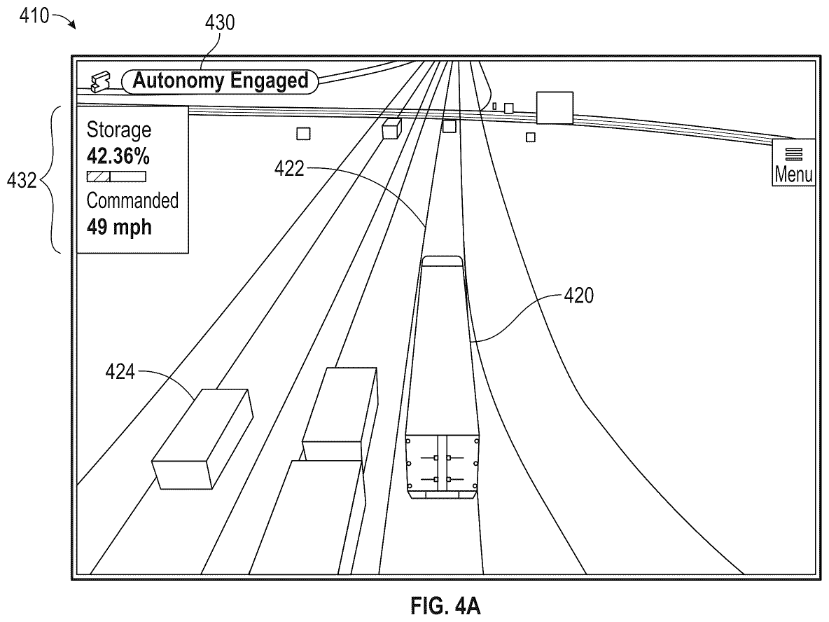

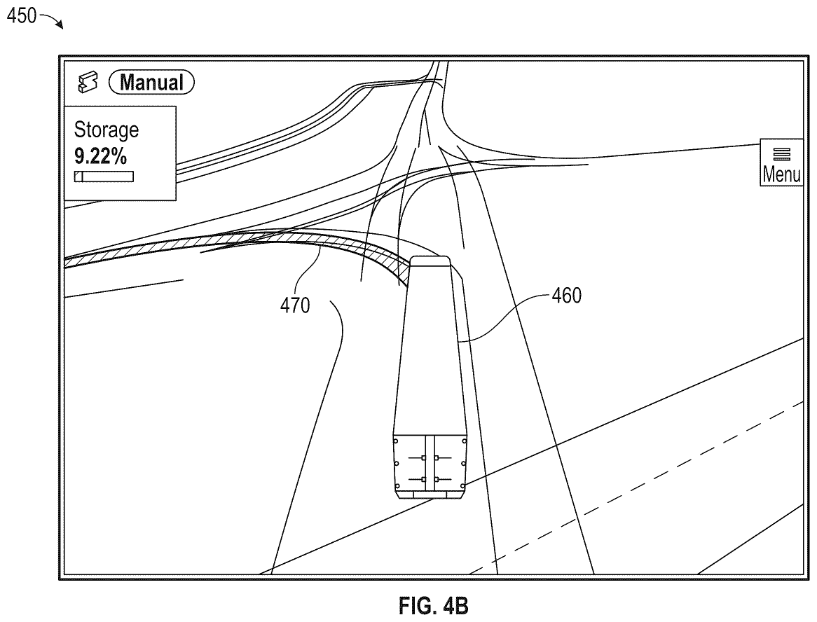

For example, as shown in FIG. 4A, a GUI view 410 of web application 114 may display a visual element 420 of the autonomous vehicle, for example based on configuration parameters entered at step 178. GUI view 410 may additionally or alternatively display visual elements corresponding to detected nearby objects including, for example, nearby object visual element 424 that may correspond to a nearby vehicle. These visual representations of detected objects may be based on cuboid models as discussed above, with dimensions and orientations derived from data received by perception system 136 and transmitted to planning system 132. GUI view 410 may additionally or alternatively display visual elements corresponding to lane markings of the roadway along which the autonomous vehicle is traveling, including lane markings of the lane along which the vehicle is traveling such as lane marking visual element 422. These visual representations of lane markings may be based on spline models as discussed above, with parameters derived from data received by perception system 136 and transmitted to planning system 132. These visual elements may update in real time, for example as perception system 136 detects changes in the environment. Such updates may ensure GUI view 410 reflects the most current state of the autonomous vehicle's surroundings and its position relative to detected objects and lane markings.

Additionally or alternatively, GUI view 410 may include an indication of the control status 430 of the autonomous vehicle indicating, for example whether a mode corresponding to autonomous control, manual control, or neither is enabled. GUI view 410 may additionally or alternatively include metrics 432 indicating for example a data storage usage, showing the percentage of memory currently in use, optionally colored based on level of usage, with green indicating low usage, yellow indicating moderate usage, and red indicating high usage. Metrics 432 may additionally include the commanded velocity of the autonomous vehicle, for example commanded by planning system 132. GUI view 410 may additionally or alternatively include indications of sensor-specific outputs, such as outputs from optical, LiDAR, and/or radar sensors, providing augmented views of the surroundings of the autonomous vehicle in certain contexts. For example, in low visibility or low light conditions, radar or LiDAR views may enhance a driver's situational awareness, whereas optical views may be helpful in situations in which the autonomous vehicle is traveling in reverse and/or navigating surface streets. Additionally or alternatively, GUI view 410 may include status indicators corresponding to the operational health of various systems, for example communication system 122, planning system 132, perception system 136, actuation system 140, and/or localization system 144, providing a user an indication of system 100's operational state.

FIG. 4B depicts an additional GUI view 450 of web application 114 that may display visual elements corresponding to one or more planned trajectories of the autonomous vehicle such as planned trajectory 470, along with a visual element 460 representing the autonomous vehicle. Visual element 460 of the autonomous vehicle may be based, for example, on configuration parameters entered at step 178. Visual elements of planned trajectories may highlight the trajectory, for example highlighting trajectory element 470 as shown in FIG. 4B. These trajectory elements may update in real time as planning system 132 generates new trajectory data and/or as the vehicle travels along the trajectory. Such trajectory elements may be overlaid over visual elements corresponding to the roadway along which the autonomous vehicle is traveling and objects proximate to the vehicle. For example, lane markings, nearby vehicles, and/or static roadway objects such as traffic signs may also be represented with visual elements to improve driver awareness. For example, one or more of the plurality of lines depicted in FIG. 4B may correspond to lane markings.

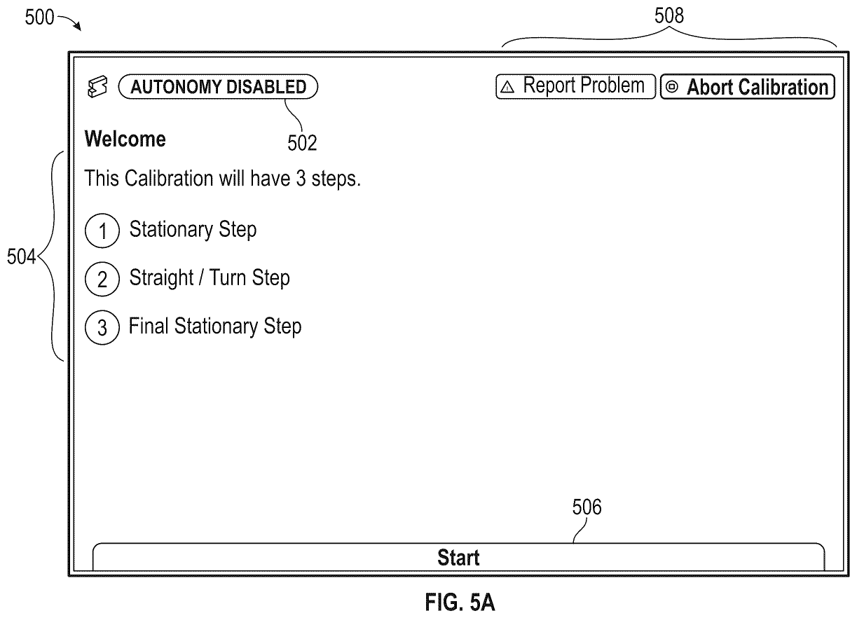

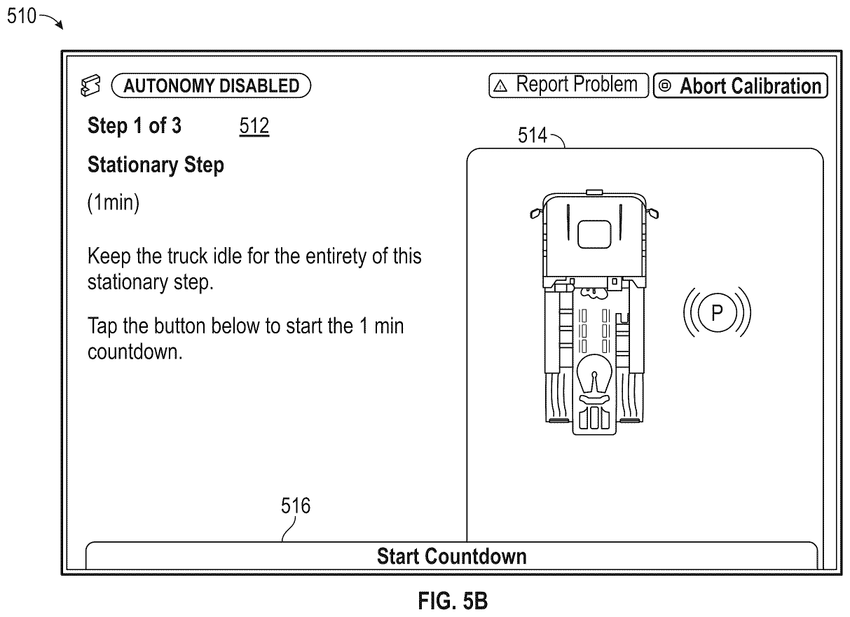

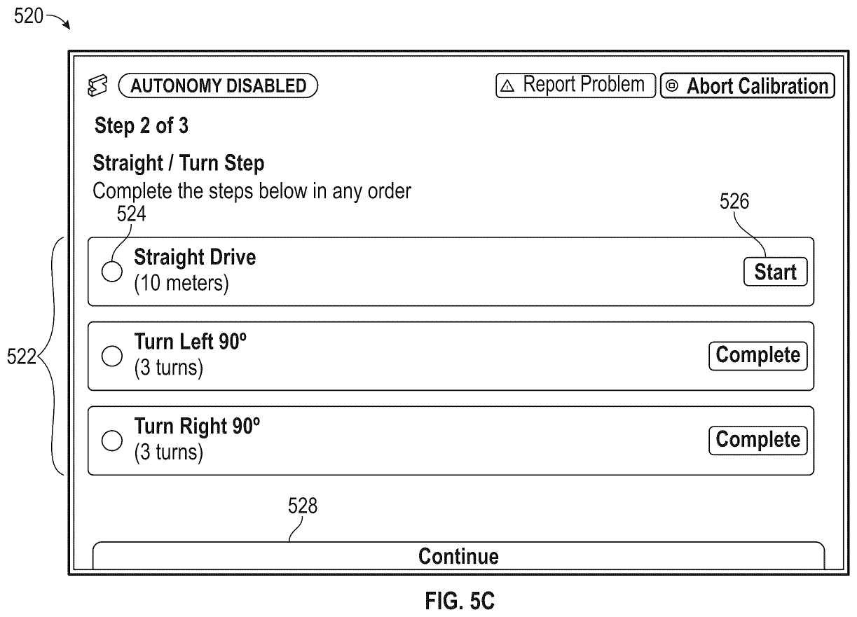

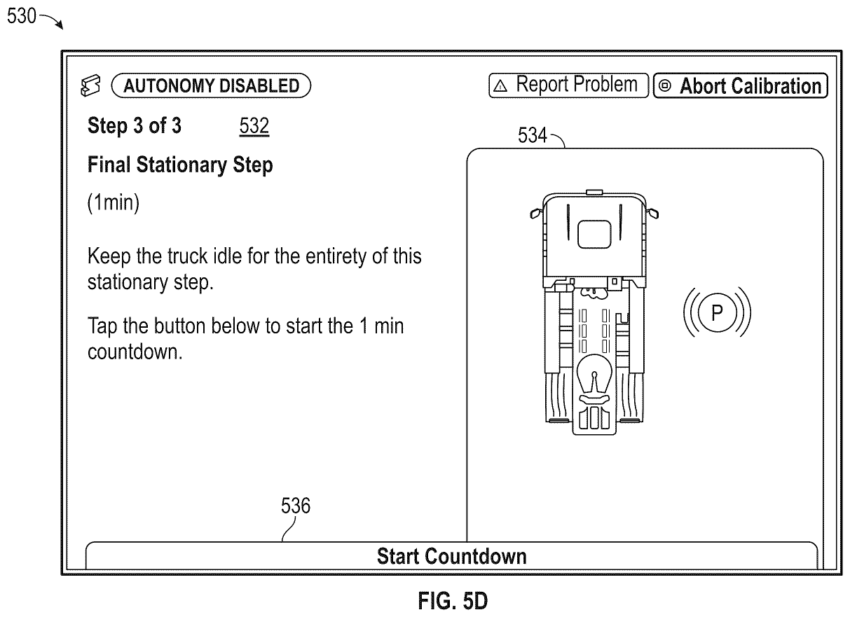

FIGS. 5A-5D depict GUI views 500, 520, 530, and 540 respectively of web application 114 corresponding to a process that system 100 may execute to calibrate autonomous control system 162. Calibration of the autonomous vehicle may serve several purposes, including ensuring that the vehicle's sensors and systems are properly aligned and functioning as expected, localizing the vehicle using sensor inputs, and/or validating the configuration parameters input at step 178, such as vehicle dimensions and/or weight.

GUI view 500 depicted in FIG. 5A may include visual elements that indicate the control status 502 of the autonomous vehicle indicating, for example whether a mode corresponding to autonomous control, manual control, or neither is enabled. GUI view 500 may additionally include visual elements indicating a summary 504 of calibration steps to be completed by a driver of the autonomous vehicle. GUI view 500 may additionally include a control affordance 506 that when selected may cause web application 114 to transmit a signal to autonomous control system 162, for example planning system 132, via autonomous control server 164, indicating that the calibration sequence should be initiated. Once initiated, autonomous control system 162 may send a return signal, via autonomous control server 164, to web application 114 indicating that the GUI view corresponding to the first step of the calibration procedure should be displayed (view 510 described below and depicted in FIG. 5B).

GUI view 500 may additionally include control affordances 508 including a report affordance that, when selected, open a further interface allowing a user to enter information corresponding to an issue or problem with the calibration process. This information may be logged within a storage of system 100 enabling follow-up by a technician or the user themselves to debug the issue. Control affordances 508 may additionally or alternatively include an abort affordance that, when selected, cancels the calibration process.

GUI view 510 depicted in FIG. 5B may include visual elements indicating information corresponding to the first step of the calibration procedure, for example a stationary step. This information may include instructions 512 and/or a corresponding image 514, in this case indicating to the driver to leave the autonomous vehicle in park mode during the duration of this step. GUI view 510 may additionally include a control affordance 516 that when selected may cause web application 114 to transmit a signal to autonomous control system 162 indicating that the first step should be initiated. Once initiated, autonomous control system 162 may send a return signal to web application 114 indicating that GUI view 510 should be updated to reflect this initiation. For example, in the case of a stationary step, this may involve displaying a countdown timer. Once the countdown timer is completed, autonomous control system 162 may send a return signal to web application 114 indicating that the GUI view corresponding to the second step of the calibration procedure should be displayed (view 520 described below and depicted in FIG. 5C).

GUI view 520 depicted in FIG. 5C may include visual elements indicating information corresponding to the second step of the calibration procedure, for example a step involving multiple driving operations. GUI view 520 may include multiple informational and control affordances 522, corresponding to each driving operation. Each informational and control affordance may include an information affordance such as informational affordance 524 indicating a completion status of the driving operation. For example, a checkmark may appear once the driving operation has been complete. Each informational and control affordance may further include a control affordance such as control affordance 526 that, when selected, may cause web application 114 to transmit a signal to autonomous control system 162 indicating that the corresponding driving operation is being completed.

GUI view 520 may additionally include a control affordance 528 that when selected may cause web application 114 to transmit a signal to autonomous control system 162 indicating that the second step of the calibration procedure has been completed. Once confirmed, autonomous control system 162 may send a return signal to web application 114 indicating that the GUI view corresponding to the third step of the calibration procedure should be displayed (view 530 described below and depicted in FIG. 5D).

GUI view 530 depicted in FIG. 5D may include visual elements indicating information corresponding to the third step of the calibration procedure, for example a final stationary step. This information may include instructions 532 and/or a corresponding image 534, in this case indicating to the driver to leave the autonomous vehicle in park mode during the duration of this step. GUI view 510 may additionally include a control affordance 536 that when selected may cause web application 114 to transmit a signal to autonomous control system 162 indicating that the third step should be initiated. Once initiated, autonomous control system 162 may send a return signal to web application 114 indicating that GUI view 530 should be updated to reflect this initiation. For example, in the case of a final stationary step, this may involve displaying a countdown timer. Once the countdown timer is completed, autonomous control system 162 may send a return signal to web application 114 indicating that GUI view 530 should be updated to reflect the status of the procedure, for example whether it was completed successfully.

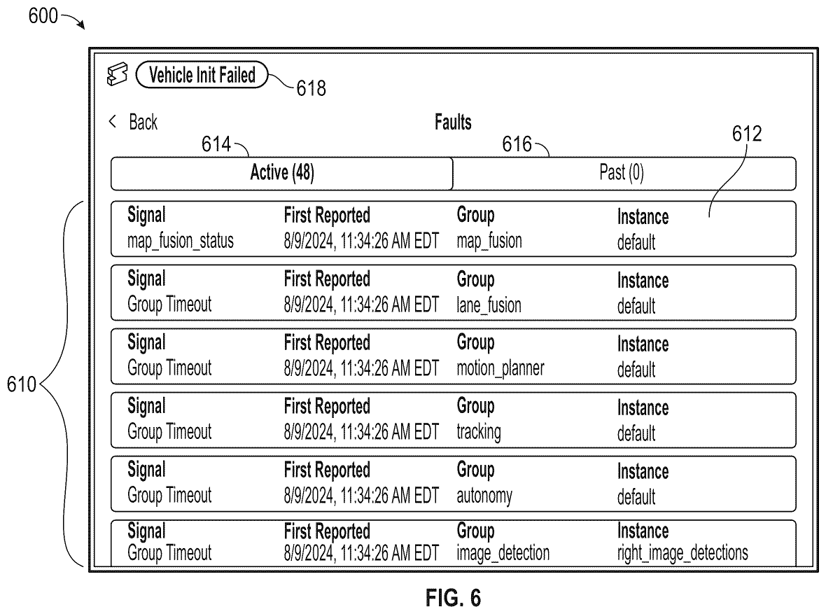

FIG. 6 depicts GUI view 600 of web application 114 including visual elements corresponding to information about one or more faults or errors that autonomous control system 162 may have experienced. Display of such faults or errors may be important in allowing a user to quickly understand which system of autonomous control system 162 has experienced a fault and/or begin to collect data that may reveal the root cause of the fault.

GUI view 600 may include a listing of one or more error information affordances 610 that, when selected, may cause web application 114 to display information corresponding to the associated error or fault, for example relating to a particular system or vehicle computing node within system 100. GUI view 600 may additionally include control status indicator 618, that may indicate a failure to initialize due to the presence of one or more faults. GUI view 600 may additionally include toggle affordances 614 and 616 that, when selected, enable a user to toggle between a list of error information affordances corresponding to active faults by selecting affordance 614 and a list of error information affordances corresponding to inactive or previously addressed faults by selecting affordance 616. For example, error information affordance 612 may display information corresponding to the particular fault, including the signal carrying the fault information, the time at which the fault was first reported, the software system or group associated with the fault, and/or the particular component or instance corresponding to the fault.

In this context, an instance may refer to a specific execution of a software component running with slightly different runtime parameters, allowing one or more copies of the same software component to operate independently within an exemplary system. Certain software components in an exemplary system may run identical code, modified only by configuration parameters. For example, a driver may support multiple LiDAR devices by varying only the IP address the driver connects to. In this way, instances may enable differentiation of multiple executions of the same software module while maintaining shared underlying code. By displaying instance-specific fault information, the system may allow a user to determine whether an issue originates from a particular execution of a software component rather than a fundamental software defect, in turn improving debugging efficiency.

Selection of error information affordance 612 may cause web application 114 to send a request for additional information corresponding to the fault, and receive a response from autonomous control system 162 including the additional information. Such additional information may include tools useful for debugging including, for example, control system logs and/or diagnostic messages.

For example, if a fault is recorded within perception system 136, a user may use the additional information including diagnostic messages showing one or more errors, such as a missing or corrupted image frame from one of the optical sensors. By reviewing these messages, the user may identify a failure to transmit images due to a hardware connection issue or a software misconfiguration, identification that may allow the user to take further remedial steps. This ability to view a listing of faults and further information pertaining to each may enable a targeted debugging process that may in turn reduce autonomous vehicle downtime.

Web application 114 may additionally or alternatively be used to support testing environments. For example, hardware components corresponding to the autonomous control system of a vehicle may be arranged in a testing environment so as to mimic the interactions and responses of the components when installed on an autonomous vehicle. Use of a web application may allow software developers and/or engineers to remotely interface with and monitor the test configuration via a network connection. For example, laptops connected to the network may communicate with the test configuration via web application 114 in the same way that a tablet or built-in display device would communicate with the vehicle's autonomous control system via web application 114, allowing visualization data to be rendered and reviewed remotely.

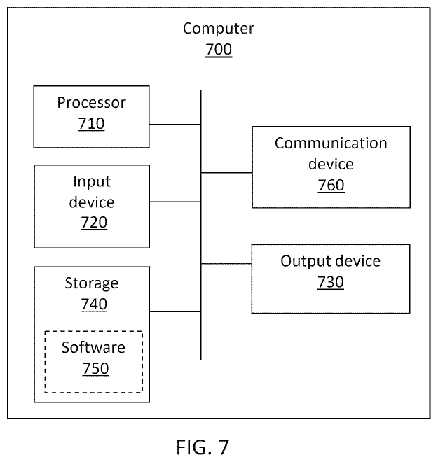

In one or more examples, the disclosed systems and methods utilize or may include a computer system. FIG. 7 depicts an exemplary computing system according to one or more examples of the disclosure. Computer 700 can be a host computer connected to a network. Computer 700 can be a client computer or a server. As shown in FIG. 7, computer 700 can be any suitable type of microprocessor-based device, such as a personal computer, workstation, server, or handheld computing device, such as a phone or tablet. The computer can include, for example, one or more of processor 710, input device 720, output device 730, storage 740, and communication device 760. Input device 720 and output device 730 can correspond to those described above and can either be connectable or integrated with the computer.

Input device 720 can be any suitable device that provides input, such as a touch screen or monitor, keyboard, mouse, or voice-recognition device. Output device 730 can be any suitable device that provides an output, such as a touch screen, monitor, printer, disk drive, or speaker.

Storage 740 can be any suitable device that provides storage, such as an electrical, magnetic, or optical memory, including a random-access memory (RAM), cache, hard drive, CD-ROM drive, tape drive, or removable storage disk. Communication device 760 can include any suitable device capable of transmitting and receiving signals over a network, such as a network interface chip or card. The components of the computer can be connected in any suitable manner, such as via a physical bus or wirelessly. Storage 740 can be a non-transitory computer-readable storage medium comprising one or more programs, which, when executed by one or more processors, such as processor 710, cause the one or more processors to execute methods described herein.

Software 750, which can be stored in storage 740 and executed by processor 710, can include, for example, the programming that embodies the functionality of the present disclosure (e.g., as embodied in the systems, computers, servers, and/or devices as described above). In one or more examples, software 750 can include a combination of servers such as application servers and database servers.

Software 750 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for displaying a graphical user interface of an autonomous vehicle using a progressive web application, the system comprising:
one or more display devices comprising one or more processors and memory storing instructions that, when executed by the one or more processors, cause the system to:
receive a progressive web application comprising the graphical user interface from a computing node communicatively coupled to the one or more display devices via a local network of the autonomous vehicle;
receive, in one or more predefined formats, one or more autonomy messages from the computing node communicatively coupled to the one or more display devices via the local network of the autonomous vehicle;
convert, based on the progressive web application and the one or more predefined formats, the received one or more autonomy messages into one or more visual elements; and
display the one or more visual elements on the graphical user interface.

2. The system of claim 1, wherein the progressive web application comprises one or more script files configured to generate the graphical user interface and convert, based on the one or more predefined formats, the received one or more autonomy messages into the one or more visual elements.

3. The system of claim 1, wherein the one or more predefined formats are based on one or more data models defined within a control system of the autonomous vehicle and the progressive web application.

4. The system of claim 3, wherein the one or more predefined formats comprise at least one format selected from a group consisting of a cuboid model format, a spline format, a waypoint format, and a format pairing an identifier with a vehicle system value.

5. The system of claim 1, wherein displaying the one or more visual elements on the graphical user interface comprises executing the progressive web application using a browser engine.

6. The system of claim 1, wherein the progressive web application is received from a web server of the computing node communicatively coupled to the one or more display devices.

7. The system of claim 6, wherein the display device continues to display the one or more visual elements on the graphical user interface in the absence of an active connection to the web server of the computing node.

8. The system of claim 7, wherein the one or more visual elements on the graphical user interface are displayed in the absence of an active connection using one or more resources associated with the progressive web application stored in the browser's cache.

9. The system of claim 8, wherein a service worker associated with the progressive web application is used to manage the caching of the one or more resources.

10. The system of claim 1, wherein the one or more autonomy messages are received from an autonomous control server of the computing node communicatively coupled to the one or more display devices.

11. The system of claim 1, wherein the computing node communicatively coupled to the one or more display devices is further communicatively coupled to a control system of the autonomous vehicle.

12. The system of claim 1, wherein the one or more visual elements on the graphical user interface comprise one or more software package information affordances that, upon selection, cause the system to display information corresponding to at least one autonomous control software package.

13. The system of claim 1, wherein the one or more visual elements on the graphical user interface comprise one or more software package download affordances that, upon selection, cause the system to download at least one autonomous control software package to a control system of the autonomous vehicle.

14. The system of claim 1, wherein the one or more visual elements on the graphical user interface comprise one or more software package installation affordances that, upon selection, cause the system to install at least one autonomous control software package onto a control system of the autonomous vehicle.

15. The system of claim 1, wherein the one or more visual elements on the graphical user interface comprise one or more configuration input affordances that, upon selection, cause the system to enable user input of at least one of a vehicle type, a vehicle length, or a vehicle weight.

16. The system of claim 15, wherein the instructions further cause the system to transmit the user input to an autonomous control server of a computing node communicatively coupled to the one or more display devices and communicatively coupled to a control system of the autonomous vehicle.

17. The system of claim 1, wherein the one or more visual elements on the graphical user interface comprise one or more calibration instruction affordances that, upon selection, cause the system to display one or more instructions for performing at least one calibration procedure associated with the autonomous vehicle.

18. The system of claim 1, wherein the one or more visual elements on the graphical user interface comprise one or more error information affordances that, upon selection, cause the system to display information corresponding to at least one error associated with the autonomous vehicle.

19. The system of claim 1, wherein the one or more visual elements on the graphical user interface comprise a real-time representation of at least one of the autonomous vehicle, a vehicle proximate to the autonomous vehicle, lane line markings, or traffic signs.

20. The system of claim 1, wherein the one or more visual elements on the graphical user interface comprise a real-time representation of at least one planned trajectory of the autonomous vehicle.

21. The system of claim 1, wherein the one or more visual elements on the graphical user interface comprise an indication of an output of one or more sensors of the autonomous vehicle.

22. The system of claim 1, wherein the one or more visual elements on the graphical user interface comprise one or more status indicators corresponding to a control system of the autonomous vehicle, wherein the one or more status indicators display at least one operational state, at least one diagnostic message, or both.

23. The system of claim 1, wherein the one or more visual elements on the graphical user interface comprise one or more selection affordances that, upon selection, cause the system to display at least one type of visual element selected from a group consisting of: vehicles proximate to the autonomous vehicle, planned trajectories of the autonomous vehicle, indications of an output of one or more sensors of the autonomous vehicle, and status indicators corresponding to the control system of the autonomous vehicle.

24. The system of claim 1, wherein the one or more display devices comprise at least one of a tablet, a laptop, a vehicle display, or a mobile phone.

25. A method for displaying a graphical user interface of an autonomous vehicle using a progressive web application, the method comprising:
receiving a progressive web application comprising the graphical user interface from a computing node communicatively coupled to the one or more display devices via a local network of the autonomous vehicle;
receiving, in one or more predefined formats, one or more autonomy messages from the computing node communicatively coupled to the one or more display devices via the local network of the autonomous vehicle;
converting, based on the progressive web application and the one or more predefined formats, the received one or more autonomy messages into one or more visual elements; and
displaying the one or more visual elements on the graphical user interface.

26. A non-transitory computer readable storage medium storing instructions for displaying a graphical user interface of an autonomous vehicle using a progressive web application, wherein the instructions, when executed by one or more processors of an electronic device, cause the device to:
receive a progressive web application comprising the graphical user interface from a computing node communicatively coupled to the one or more display devices via a local network of the autonomous vehicle;
receive, in one or more predefined formats, one or more autonomy messages from the computing node communicatively coupled to the one or more display devices via the local network of the autonomous vehicle;
convert, based on the progressive web application and the one or more predefined formats, the received one or more autonomy messages into one or more visual elements; and
display the one or more visual elements on the graphical user interface.
